(19) United States
(12) Patent Application Publication
(10) Pub. No.: US 2007/0157757 A1
(43) Pub. Date: Jul. 12, 2007

(54) Shifting method and system for a vehicle transmission

(76) Inventors: Christopher Charles Trevino, Temecula, CA (US); Gerhard Heinrich Fiedler, Buena Park, CA (US)

Correspondence Address: LOUIS L. DACHS, 1794 PALISADES DRIVE, PACIFIC PALISADES, CA, 90272, US

(21) Appl. No.: 11/329,352

(22) Filed: Jan. 10, 2006

(51) Int. Cl. G05G 1/04

(52) U.S. Cl. 74/519

(57) ABSTRACT

The invention is a transmission shifting method and system for vehicle, the vehicle having a transmission having a push-pull member for operating the transmission movable from a first starting position to a second upshift position or to a third downshift position. In detail, the invention includes a method and system to drive the push-pull member such that when moving the push-pull member from the second position to the first position moves the push-pull member past the first position and then back to the first position and when moving said push-pull member from the third position to the first position moves said push-pull member past the first position and then back to the first position;

### BACKGROUND OF THE INVENTION

1. Field of the Invention

The invention relates to the field of shifting systems for transmissions for automobiles and the like and, in particular, to a shifting system for a transmission having a sequential actuation system.

2. Description of Related Art

Originally, all transmission shifting was accomplished manually with a stick type shifter positioned on the floor. However, this made three abreast seating in the front seat of the automobile difficult. To provide for three abreast seating in the front seat, column-mounted manual shifting systems became popular. This mounting position remained popular even when automatic transmissions were introduced. However, sport cars and most racing cars still used floor-mounted shifters. Chrysler Corporation in the 1950's time frame introduced a transmission controlled by push-buttons located in the center of the steering wheel hub. However, it proved to have a short life and the column mounted shift lever remained the standard.

When the sports or sporty cars became popular, the trend reverted back to mounting the shifter on the floor, in reality on top of the transmission. In fact, with the advent of “bucket seats” limiting the front of the passenger compartment to two, center mounting the shifter was a significant cost saver. However, more recent advancements, particularly in Formula One racing cars, have produced automatic shifting manual transmissions. That is a manual type transmission with a clutch that can be automatically shifted by use of electronics and hydraulic or electric actuators. This advancement led to the placement of the shifting mechanism back on to the steering column, where paddles and the like accomplish shifting. Presently, this concept is being introduced into production automobiles. In fact, it is being used in conjunction with automatic transmissions on cars manufactured by Porsche and the Pontiac Division of General Motors. Many other manufactures are expected to follow with such shifting systems.

An alternate approach has been to design manual transmissions such that a floor mounted shift lever, connected by a push-pull cable to the transmission, is only moved forward for upshifts and backward for downshifts, often without the use of the clutch pedal. Thus up-shifting goes from neutral to gears 1, 2, 3, 4, etc.; downshifting goes from gears 4, 3, 2, 1 to neutral. A separate second gear shift lever is used for reverse, which can only activate when the transmission is in neutral. Typically, all that is required to make a shift between forward gears is a slight lifting of the gas pedal while the shift is made. To go into reverse, the first shift lever must be in neutral. These types of transmissions are commercially available, and used primarily in racing cars and off road vehicles. Mendeola Transaxles Incorporated, Chula Vista, Calif., markets a transaxle of this type. It would also be desirable to provide for the conversion of these types of transmissions to make shifting control available on the steering wheel. PBS Engineering, Garden Grove, Calif. makes and uses a paddle shifter system mounted on the steering wheel. Even though the steering wheel mounted paddles activate electrical switches, the system itself is pneumatically powered and requires an air supply system. Other systems use hydraulics, which also require a separate hydraulic system for transmission shifting.

Thus, it is a primary object of the invention to provide a transmission shifting system that converts a floor mounted or column mounted shifting system to a steering wheel mounted system.

It is another primary object of the invention to provide a transmission shifting system that converts a floor mounted or column mounted shifting system to a steering wheel mounted system for after-market installation on automobiles.

It is a still further object of the invention to provide a transmission shifting system that that is electrically powered and easily installed.

It is a still further object of the invention to provide a transmission shifting system for a transmission that sequentially shifts between gears.

### SUMMARY OF THE INVENTION

The invention is a transmission shifting system for automobiles. The automobile includes a transmission having a push-pull member for operating the transmission, movable from a first starting position to a second upshift position or to a third downshift position. The system includes a reversible electric gear motor, having an output shaft, the motor capable of rotating the shaft in first and second directions. Preferably, the motor includes an anti-backlash gear system between the motor and output shaft. A first mechanism is provided for coupling the output shaft of the motor to the push-pull member of the transmission such that rotation of the shaft in the first direction moves the push pull member towards the first position and rotation of the shaft in the second direction moves the push-pull member towards the third position.

A transmission control system is coupled to the motor for actuating the motor to move the push-pull member on the transmission from the first position to the second position and back to the first position upon receipt of a first signal, and to move the push-pull member from the first position to the third position and- back to the first position upon receipt of a second signal. A second system is provided for providing the first and second signals. Preferably, when moving the push-pull member from the second or third position back to the first position, the control system moves the push-pull member past the first position (overshooting) and then back to the first position. The preferred overshooting is 20 percent of the total movement from the first position to the second or third position.

The automobile includes a steering wheel with a gear selection system mounted thereon, which provides the first and second signals to the transmission control system.

This method of upshifting and downshifting a transmission system for the automobile includes these steps: for up-shifting: 1) moving the push-pull member from first position to the second position; 2) moving the push-pull member back past the first position; and 3) moving the push-pull member to the first position. For downshifting, the steps include: 1) moving the push-pull member from first position to the third position; 2) moving the push-pull member back past the first position; and 3) moving the push-pull member to the first position.

The novel features which are believed to be characteristic of the invention, both as to its organization and method of operation, together with further objects and advantages thereof, will be better understood from the following description in connection with the accompanying drawings in which the presently preferred embodiments of the invention are illustrated by way of examples. It is to be expressly understood, however, that the drawings are for purposes of illustration and description only and are not intended as a definition of the limits of the invention.

### BRIEF DESCRIPTION OF THE DRAWINGS

FIG. 1 is a partial view of the interior of an automobile dashboard, steering column and center console with transmission shifter.

FIG. 2 is side view of a vehicle equipped with the transmission shown in FIG. 1.

FIG. 3 is a perspective view of a steering wheel having shifting controls thereon.

FIG. 4 is a partial side view of a transmission incorporating an electric motor driven transmission shifting system.

FIG. 5 is a partial top view of the transmission shown in FIG. 4.

FIG. 6 is a view similar to FIG. 4, illustrating a second version of the shifting system.

FIG. 7 is a partial view of FIG. 4 illustrating the movement of the shifting lever.

FIG. 8 is a functional diagram of the control system for the transmission shifting system.

FIG. 9 is a typical computer screen from a PC computer that is used to program the transmission shifting system.

FIGS. 10A and 10B are a flowchart of the internal software for operating the transmission shifting system.

FIG. 11A and 11B are a flowchart of the software that is ran internally on the transmission shifting system for determining when a shift is permitted.

FIG. 12 is a top view of an alternative system wherein a hydraulic actuator is coupled to the transmission.

### DESCRIPTION OF THE PREFERRED EMBODIMENT

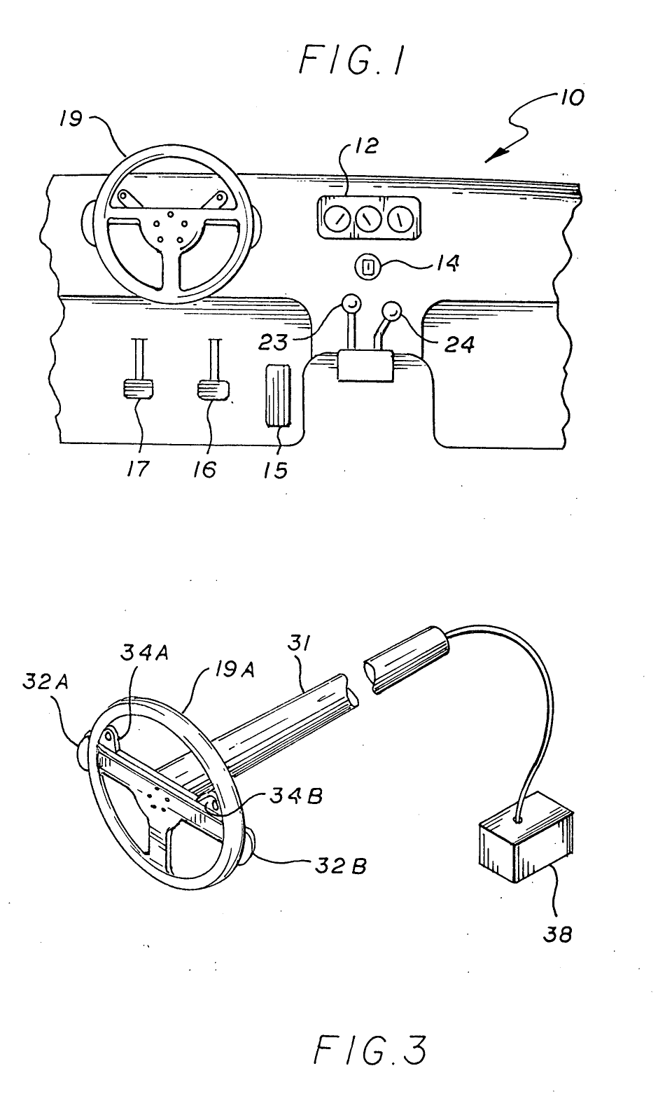

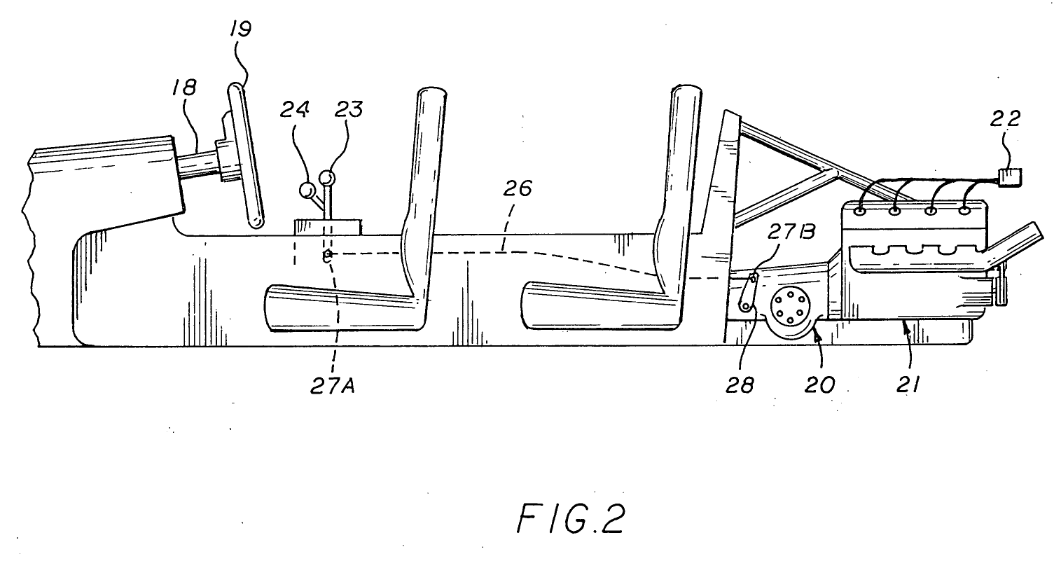

Referring to FIGS. 1 and 2, which is a partial view of the dashboard of a prior art automobile. The dashboard 10 includes an instrument panel 12, a transmission gear display 14. Also illustrated are the gas pedal 15, brake pedal 16 and clutch pedal 17. Also illustrated are the steering column 18 and steering wheel 19, and transmission 20 coupled to an engine 21 with an engine management system 22.

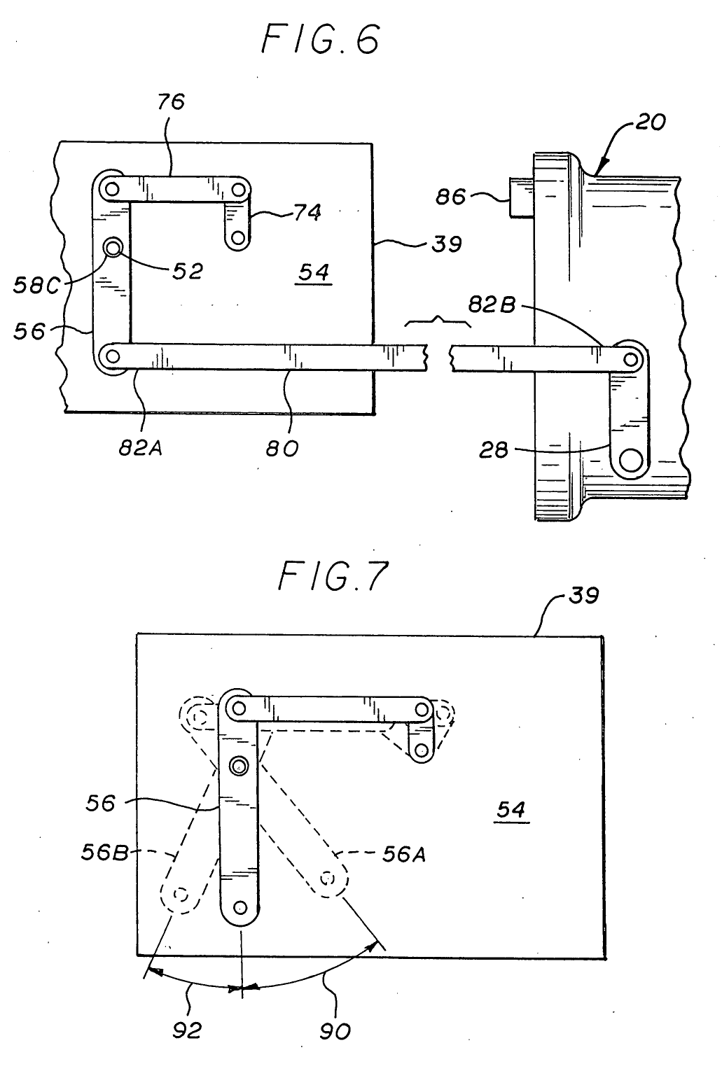

Referring to FIGS. 2 and 5, the sequential transmissions are shifted using two center mounted shift levers. The first shift lever 23 (forward shift lever) is a tall straight lever that moves from a centered position forward and backwards. Lever 23 controls the forward gears and neutral, and always tries to return itself to the centered position after a shift, so that it is ready for another shift action. The second. lever 24 is typically a shorter bent handle that controls reverse. Reverse can only be selected when the transmission is in neutral. The reverse shift lever locks into the reverse position and this mechanically prevents forward shifts from occurring inside the gearbox. Shift lever 23 is connected by a push-pull type shift cable 26 to the transmission 20. The cable 26, has a first end 27A connected to the. lever 23 and a second end 27B connected to a shift lever 28 on the transmission 20. Rotating lever 28 in one direction will cause the transmission to upshift and in the opposite direction to downshift. A push-pull type cable 29 connects lever 24 to the transmission 20.

Driving the sequential gearbox is very similar to driving a normal stick shift (H pattern) vehicle. The only difference is that instead of shifting in the H pattern style, one simply pulls or pushes the forward shift lever 23 to change gears. For example, if a driver is in neutral and wishes to start moving, one must depress the clutch and press shift lever 23 into the upshift position (pushing forward). Then lever 23 is allowed to return to the centered position, and the transmission is now in 1st gear. Thereafter the clutch is released while the gas is applied by pressing the gas pedal 15. This procedure is used to upshift. through all the gears. The procedure is used for downshifting, except the lever 23 is pulled backward instead of pushed forward.

Some drivers do not like using the clutch once they are moving, and prefer to “blip” the throttle. Blipping the throttle involves removing the driver's foot from the gas for just enough time to allow the torque applied to the gears by the motor to relax enough to allow a shift to occur. This method produces a slightly faster shift, because the shift sequence requires less movements from the driver. In the subject invention, cable 26 is disconnected from the lever 23, which is removed in it's entirely.

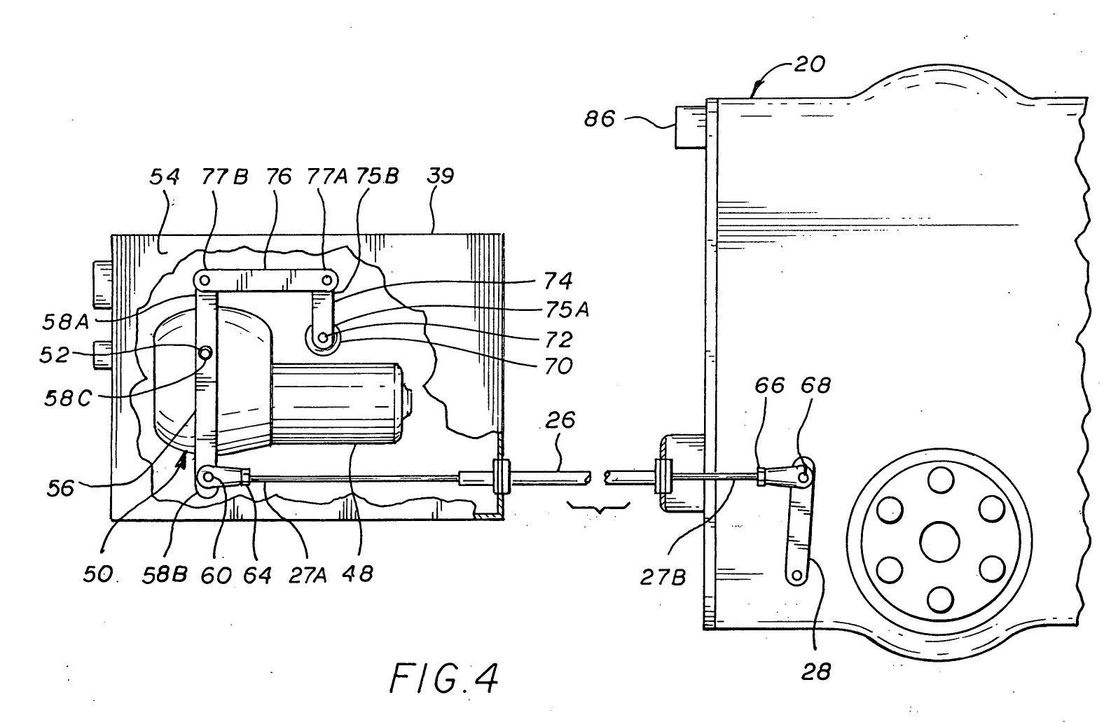

The subject invention eliminates the need for the driver to take his or her hands off of the steering wheel. Referring to FIG. 3, a commercially available steering wheel 19A having a “paddle wheel switch” or push button system can be used, which replaces the shift lever 23 and steering wheel 19 mounted on steering column 31. The wheel shifter 19A is available from American Supercars and Prototypes, LLC. Fallbrook, Calif. The steering wheel includes paddle switches 32A and 32B for upshifting and button type switches 34A and 34B for downshifting. Of course, some models will have only paddle switch 32A for upshifting and paddle switch 32B for downshifting. In the model shown in FIG. 3, an electrical signal is sent down the steering column 31 to a controller 38, which controls upshift and downshift movements, the operation of which will be subsequently discussed. The Twist Machine, LLC., Hampton, N.Y., manufactures a paddle type steering wheel which uses an RF signal generator mounted in the steering wheel which can be used to send the signals to the transmission shifting controller 38.

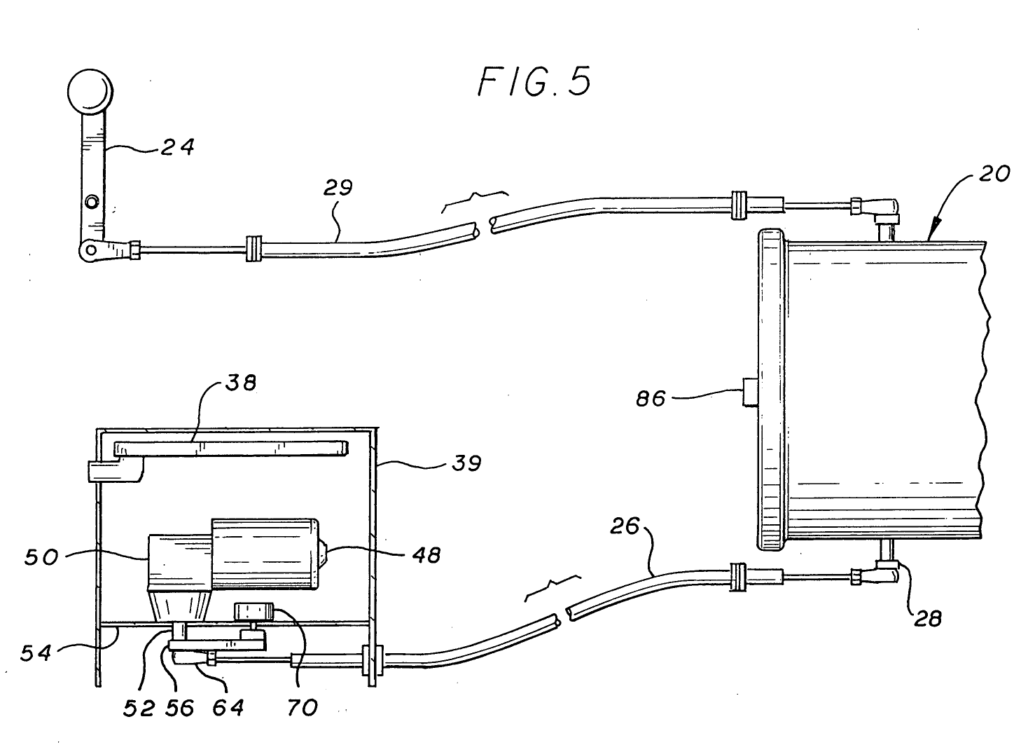

Still referring to FIGS. 1-3 and additionally to FIGS. 4 and 5, a housing 39 is mounted in proximity to the transmission 20. The housing 39 contains the transmission shifting controller 38 and includes an electric motor 48 having an anti-back lash gear reduction unit 50 coupled to an output shaft 52 that extends out of a side wall 54 of the housing 39. A suitable combination electric motor and anti-backlash gear assembly is Part No.: 9390453042, manufactured by Robert Bosch Limitada, Campinas, Brazil. A lever 56 having first and second ends, 58A and 58B, respectively, and a middle hole 58C is mounted to the shaft 52 by its middle hole 58C. The second end 58B includes a ball fitting 60. The first end 27A of the cable 26 includes a quick disconnect fitting 64 adapted to mate with ball fitting 60. The cable is preferably Part Number 175403-001XQ, manufactured by Control Cables, Incorporated, Santa Fe Springs, Calif. Thus the ball fitting 60 is in releasable engagement with the quick disconnect fitting 64. The second end 27B also ends in a quick disconnect fitting 66 coupled to a ball fitting 68 on the lever 28 on the transmission 20.

A position sensor 70 is coupled to the sidewall 54 of the housing 39 and having an output shaft 72. A lever 74 is rigidly coupled by its first end 75A to the shaft 72. A link 76 is pivotally coupled by its first end 77A to the second end 75B of the lever 74 and by its second end 77B to the first end 58A of lever 56. Thus when lever 56 rotates, the position sensor 70 can measure its angular position, which in turn, measures the position of the lever 28 on the transmission 20.

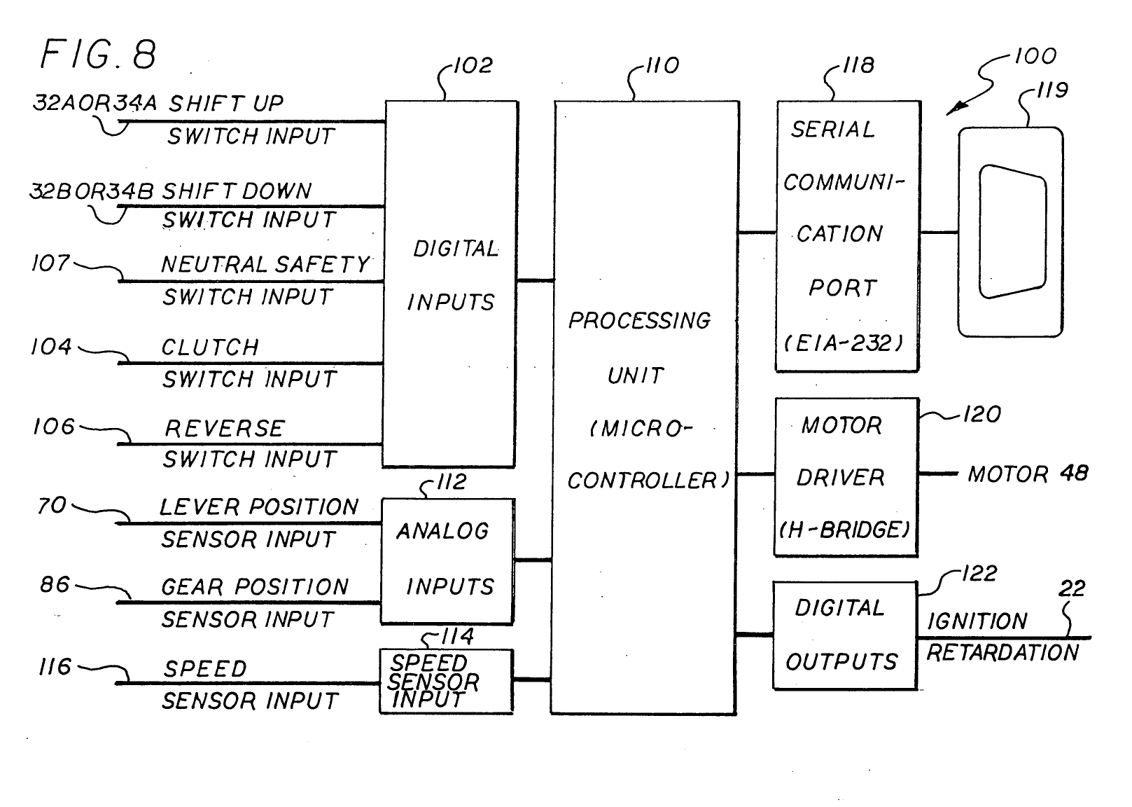

Referring to FIG. 6, the lever 56 could be connected through a rigid link rather than through a cable to the lever 28. This could be accomplished by means of a rigid link 80 pivotally connected on its ends 82A to the lever 56 and by its end 82B to the lever 28. However, the use of cables allows some latitude in the placement of the housing 39.

Referring back to FIGS. 1-5, the transmission 20 comes equipped with a gear selection sensor 86, which is coupled to a gear display 14 on the dashboard 10; however it could be incorporated on to the steering wheel 19.

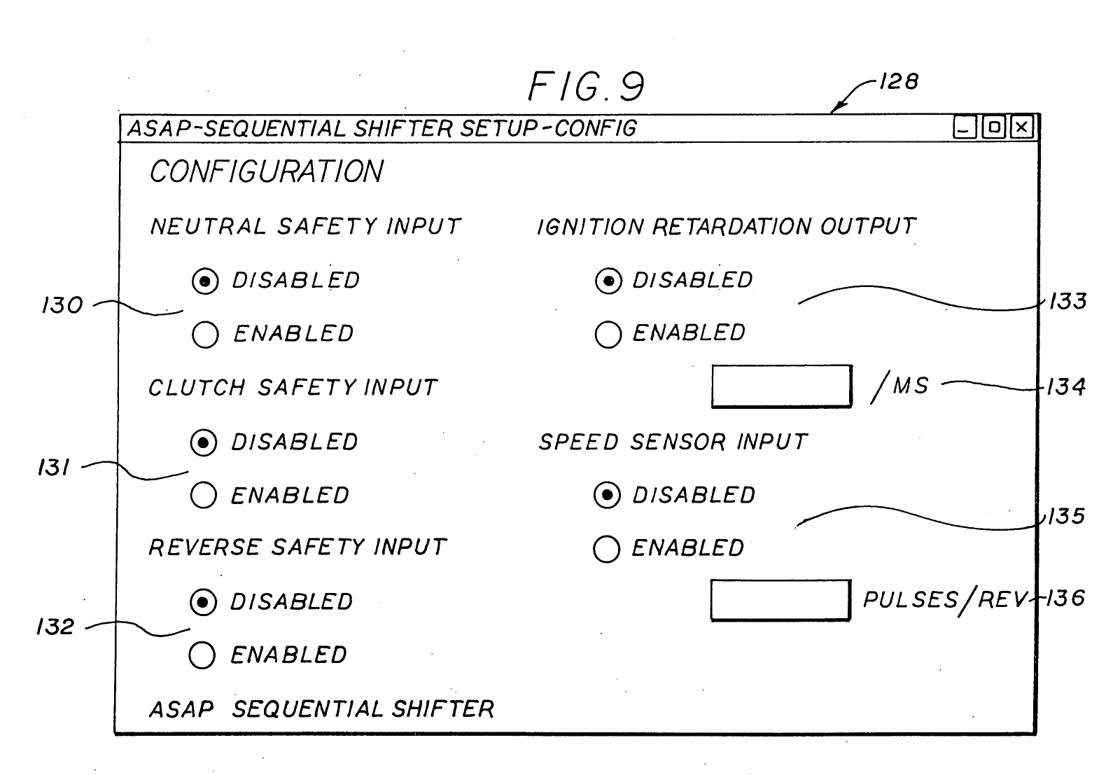

When initiating a shift, the system is programmed in a manner (to be subsequently discussed) to cause the motor 48 to rotate the lever 56 so that the lever 28 on the transmission 20 shifts a gear. As illustrated in FIG. 7, the lever 56 rotates over an angle 90 to the position indicated by numeral 56A. However, when it is rotated back it moves past the start position to the position indicated by numeral 56B over an angle 92 and then back to the starting position. This insures that transmission 20 has properly shifted and its internal mechanical parts are in a position to make the next shift. This procedure it used for both upshifts and downshifts. The angle 92 is approximately 20 percent of angle 90.

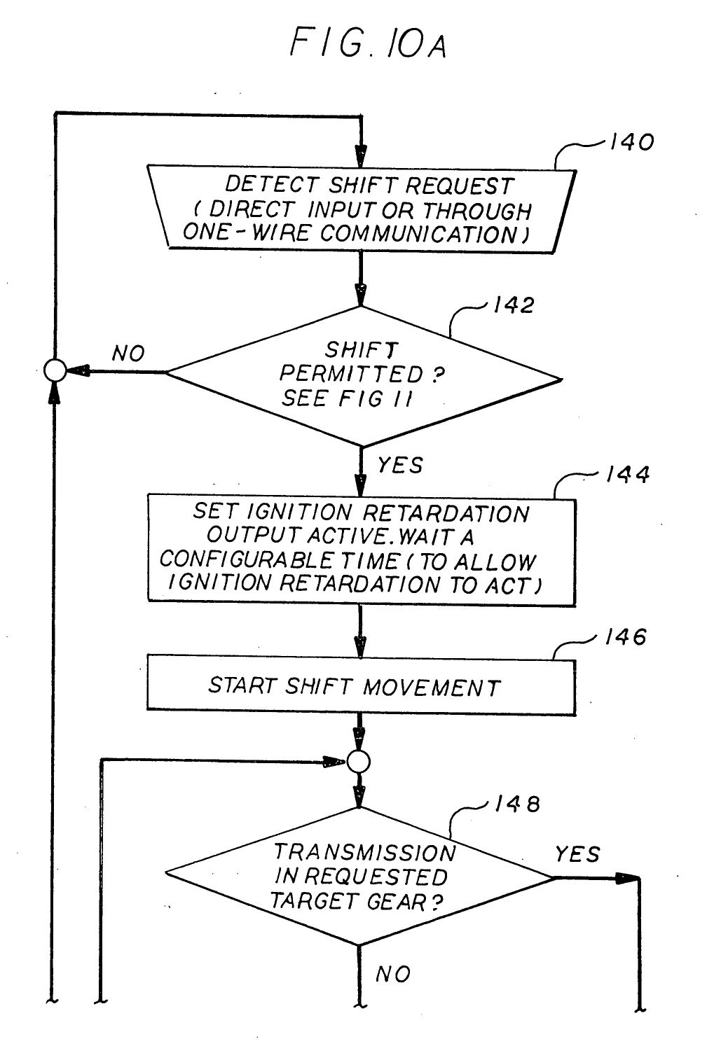

Referring to FIG. 8, the shifting controller 38 further includes a control circuit, indicated by numeral 100, which includes a digital input device 102 that receives upshift and downshift signals, a signal from a clutch position switch 104 coupled to the clutch pedal 17, reverse position switch 106 coupled to the second lever 24 and neutral safety switch 107. The neutral safety switch 107 can be located on the dash of the automobile. A suitable digital input device is Part No.; MC33993DWB manufactured by Freescale Semiconductor, Austin, Tex. The output from the digital input device 102 is provided to a microprocessor 110. A suitable microprocessor is Part No.: PIC18F67722-E/PT manufactured by Microchip Technology, Chandler, Ariz.

Also included is an analog input device 112 that receives input from the gear selection sensor 86, and from the electric motor position sensor 70. A suitable analog input device is Part No.: MCP6002E/SN manufactured by Microchip Technology, Chandler, Ariz. The output from the analog input device is also coupled to the microprocessor 110. Finally, a speed sensor 116 can be provided that is coupled to the microprocessor 110 via a speed sensor device 114. A suitable speed sensor input device is Part No.: CS1124YD8 also manufactured by Microchip Technology, Chandler, Ariz. Also coupled to the microprocessor 110 is a serial communication port 118 to allow programming by means of a personal computer 119. One output from the microprocessor 110 is a motor driver 120. The motor driver 120 supplies current to the motor to drive it either clockwise or counter clockwise, so as to cause an upshift or downshift. Finally a digital output 122 is provided to provide a signal to the engine management system 22 on the engine 21 for momentary torque reduction during shifting.

In the above system the following items are optional:
1. Gear selector display 14.
2. Neutral Safety Switch 107—When this option is enabled, a shift from forward gears into neutral will not be permitted unless a separate switch is activated. That is going from 1^{st} into neutral would only occur when the neutral safety switch is activated.
3. Clutch Switch 104—When this option is enabled, the driver will not be able to shift out of neutral and into a forward gear without this switch being activated. The clutch switch is typically mounted so that it is activated by depressing the clutch pedal 17.
3. Reverse Switch 106—When this option is enabled, the shifter unit will not attempt to shift when the reverse switch is activated. The reverse switch is typically mounted to the reverse shift lever 24.
4. Digital Output 122—When this option is enabled, a signal is sent out to the engine management system 22 to cut the throttle, retard the timing, or use any other means to momentarily reduce the engine torque so that a shift can occur without the driver releasing the gas pedal 15.
5. Speed Sensor 114—When the RPM Safety option is enabled, the shifter unit will not downshift until a certain speed/rpm limit is met. The purpose of this feature is to limit over-revving when downshifting.

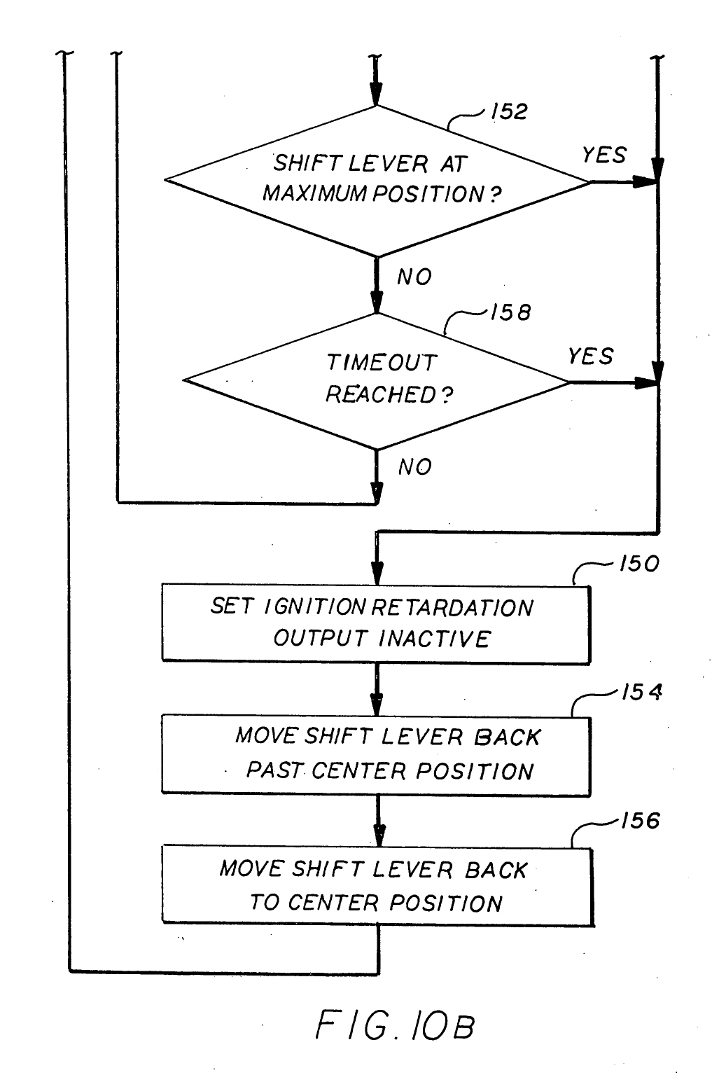

FIG. 9 illustrates a computer screen presentation 128 that is used to activate the optional devices. As can be seen, the neutral safety switch 107 is covered by input 130, the clutch switch 104 by input 131, and the reverse switch is covered by input 132. The digital output 122 for torque reduction is covered by input 133 and the text box 134 for the pre-shift time delay. Speed sensor 114 is covered by input 135, with the RPM limit settable by text box 136. Thus control is easily accomplished by use of the personal computer 119 using the software 128.

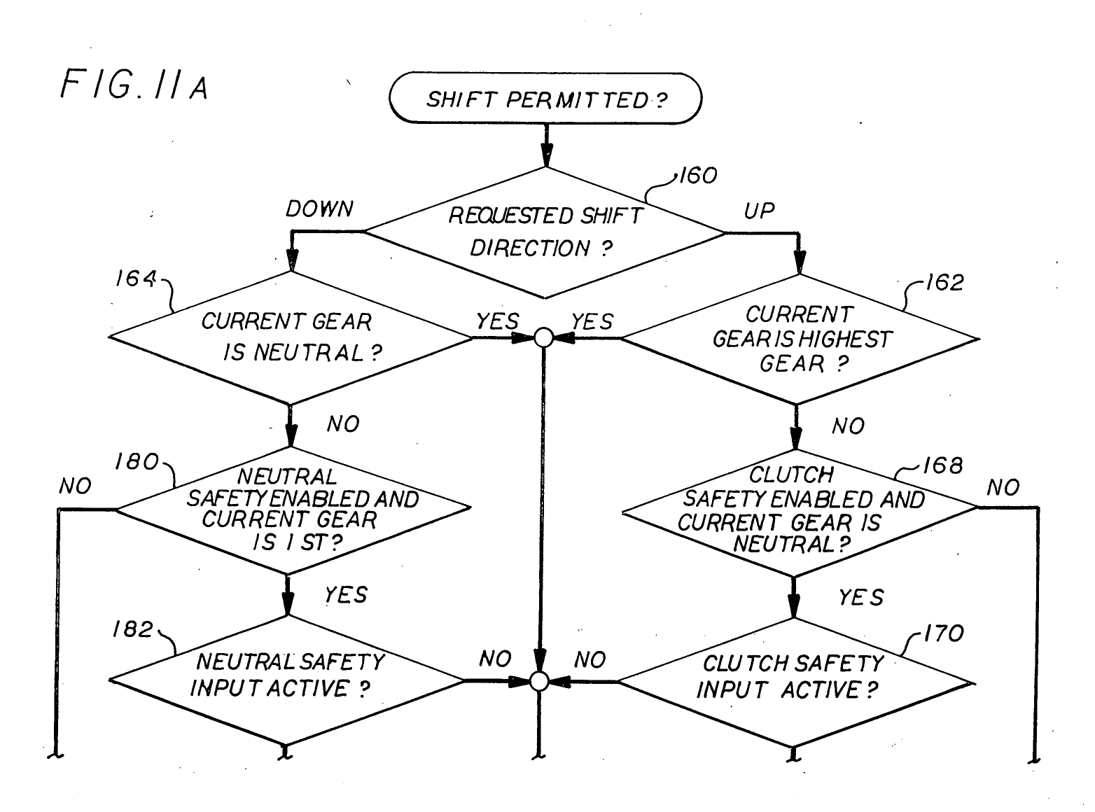

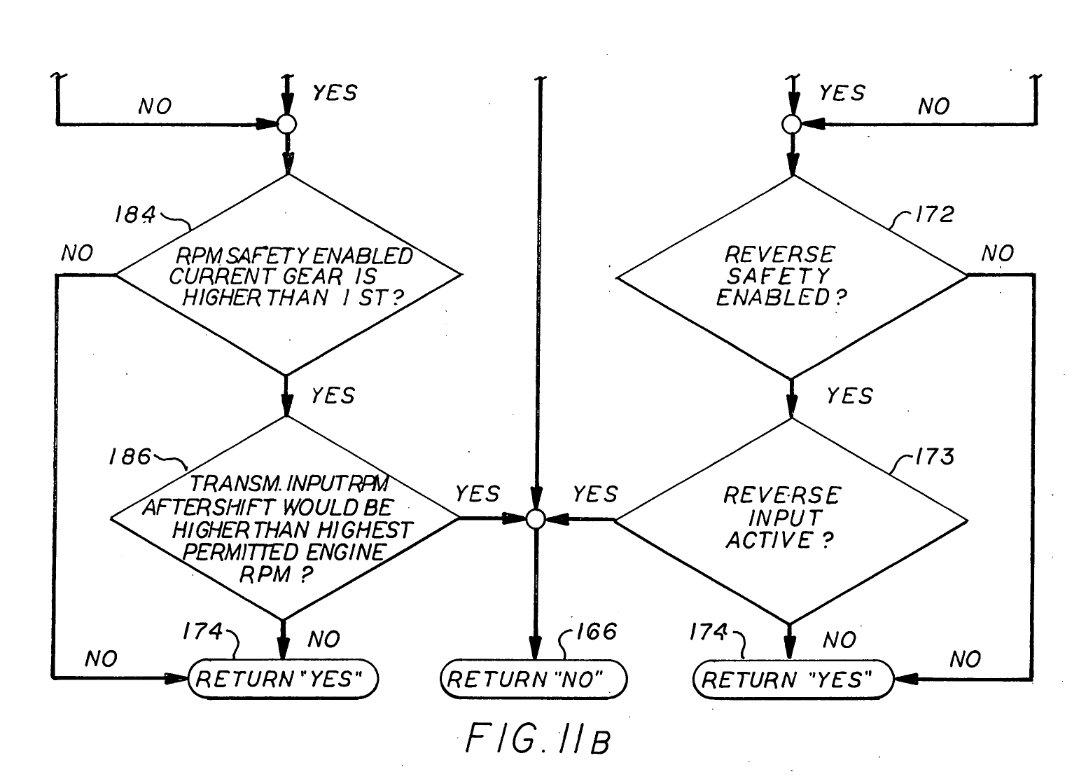

Presented in FIGS. 10A and 10B is a flowchart of the computer program contained in the microprocessor 110 and involves the following steps: Step 140—Detect Shift Request. Detects a signal from steering wheel mounted paddle switches 32A, 32B or button switches 34A, 34B. Step 142—Determine If Shift Allowable. This procedure is illustrated in FIGS. 11A and 11B and will be subsequently discussed. If yes (shift is permitted), go to Step 144; if not, return to Step 140. Step 144—Set Torque Reduction Output. A signal is sent via the digital output 122 to the engine management system 22 to retard the timing, cut the ignition, or otherwise reduce the torque. This will reduce the engine torque on the transmission gears so that a shift can be performed with a depressed gas pedal. The signal is sent to the engine management system prior to the start of the shift, and remains active the whole time the shift is occurring. If this option is not used, the driver will have to either “blip” the throttle or use the clutch for shifting. Step 146—Start Shift Movement. The electric shift motor 48 starts moving the lever 56 from start position towards position 56A (see FIG. 7). Step 148—Determination If Transmission Reached Target Gear. This is determined by reading the gear selection sensor 86 mounted on the transmission 20. If the transmission has reached the target gear, then to Step 150; if not, to Step 152. Step-150 Set Engine Torque Reduction Output To Inactive. The shift is now completed and the engine can again run with full torque. Step 152—Determine If Shift Lever 56 At Max Position. If yes, to Step 150; if not, to Step 158. Step 154—Move Shift Lever 56 Back Past Center Position. The shift lever 56 is now moved to position 56B, past center (see FIG. 7). Step 156—Move Shift Lever 56 To Center Position. This concludes the shift process. After this step, go back to step 140 and wait for the next shift signal. Step 158—Time Out Reached. A timeout occurs when a shift is taking longer than expected to complete. Usually this is caused by a mechanical obstruction, which is not allowing the transmission to reach its target gear and thus not allowing the motor and lever 56 to move to the maximum position. The motor just continues to try to make the obstructed shift, until a pre-set period of time is reached. If this timeout is reached without completing the shift, to Step 150; if not, return to Step 148 and continue waiting.

The flow chart for Step 142 Determine If Shift Allowable is illustrated in FIGS. 11A and 11B. Step 160—Determination Of Shift Direction. If upshift, to Step 162, if downshift, to Step 164. The following checks happen during an upshift. Step 162—Determination If Selected Gear is Highest. If yes, to Step 166; if not, to Step 168. Step 166—Determination that shift is not permissible and return to processing according to FIG. 10. Step 168—Determine If Clutch Switch Enabled And Current Gear Is Neutral. If the clutch switch option 131 is not enabled or the transmission is not in neutral, then to Step 172; else to Step 170. If the driver has elected to use the clutch option, then a check is made to determine as to whether the transmission is in neutral (sensor 86). If the transmission is not in neutral, then there is no need to check to see if the clutch switch 104 is active. The clutch safety feature is used to prevent that the driver inadvertently shifts into a forward gear without pressing the clutch pedal while the vehicle is idling in neutral. Step 170—Determine If Clutch Petal Depressed. If the clutch switch 104 is not active, to Step 166. This means the clutch is not depressed and a shift out of neutral will not occur. Otherwise, to Step 172. Step 172—Is Reverse Safety Enabled. If the reverse safety is not enabled, to Step 174. If it is enabled, to Step 173 for checking the reverse switch. Step 173—Is Reverse Switch Active. If the reverse switch is active, the transmission is in reverse gear and the device will not attempt any shifts. In this case, to Step 166. Otherwise to Step 174. Step 174—Determination that shift is permitted and return to processing according to FIG. 10.

The following steps are used to check the validity of a downshift. Step 164—Determine if Current Gear Is Neutral. If yes, to Step 166; if no, to Step 180. Step 180—Determine If Neutral Safety Enabled And Current Gear Is 1^{st} Gear. If neutral safety is enabled and the sensor 86 indicates that the transmission is in 1^{st} gear, to Step 182; otherwise, to Step 184. Step 182—Determine Neutral Safety Switch Active. If yes, to Step 184; if no, to Step 166. Step 184—Determine If RPM Safety Active And Current Gear Higher Than 1^{st} Gear. If RPM Safety is disabled or the current gear is the 1^{st} gear, to Step 174; otherwise, to Step 186. Step 186—If the RPM Safety is enabled, then the program checks whether the input rpm after the shift would be higher than the maximum permitted engine rpm. If yes, the shift is not allowed and the program branches to Step 166. If no, the shift is allowed and the program branches to Step 174.

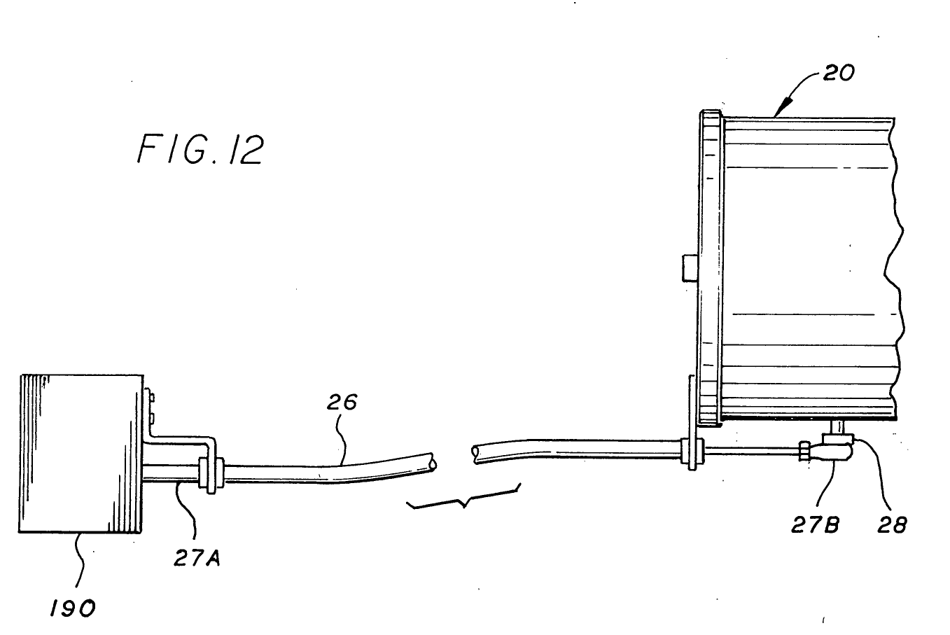

While an electric motor is preferred because of the above stated reasons, a hydraulic or pneumatic actuator could be used. Referring to FIG. 12, it can be seen that a hydraulic actuator system 190 (could be a pneumatic actuator system) is shown directly coupled to end 27A of the cable 26, with all other components being identical. Such systems could be used to move the push-pull member in the manner previously described.

This method of upshifting and downshifting a transmission system for the automobile includes the following steps for upshifting: 1) moving the push-pull member from first position to the second position; 2) moving the push-pull member back passed the first position; and 3) moving the push-pull member to the first position. For downshifting, the steps include: 1) moving the push-pull member from first position to the third position; 2) moving the push-pull member back passed the first position; and 3) moving the push-pull member to the first position.

Thus it can be seen that by using an electric motor with anti-backlash gears, steering wheel mounted shifting switches, the transmission shifting program in the microprocessor, and the various sensors and switches, shifting can be accomplished without the driver removing his or her hands from the steering wheel. Additionally, the safety interlocks insure that inadvertent shifting into the wrong gear position or over-revving of the engine can be prevented. While the electric motor is preferred, the method of shifting the direct drive transmission can use a hydraulic or pneumatic actuator. In addition, it must be noted that, while an automobile transmission is used as an example, other vehicles, such as boats, can make use of this invention.

While the invention has been described with reference to particular embodiments, it should be understood that the embodiments are merely illustrative, as there are numerous variations and modifications, which may be made by those skilled in the art. Thus, the invention is to be construed as being limited only by the spirit and scope of the appended claims.

### INDUSTRIAL APPLICABILITY

The invention has applicability primarily to the automobile and boat industries.

1. A transmission shifting system for a vehicle, the vehicle having a transmission having a push-pull member for operating the transmission movable from a first starting position to a second upshifting or to a third downshift position; the system comprising:
a reversible electric motor, having an output shaft, said motor capable of rotating said shaft in first and second directions;
first means for coupling said output shaft of said motor to said push-pull member of the transmission such that rotation of said shaft in a first direction moves the push-pull member toward the first position and when said shaft rotates in the second direction to the third position;
transmission shifter control means for actuating said motor to move the input member from the first position to the second position and back to the first position upon receipt of a first signal, and to move the push-pull member from the first position to the third position and back to the first position upon receipt of a second signal; and
second means for providing the first and second signals.

2. The system as set forth in claim 1 wherein said transmission control means includes:
when moving the push-pull member from the second position to the first position moves said push-pull member past the first position and then back to the first position; and
when moving said push-pull member from the third position to the first position moves said push-pull member past the first position and then back to the first position.

3. The system as set forth in claim 2 wherein
when moving said push-pull member from the second position to the first position moves said push-pull member past the first position and then back to the first position, the distance past the first position is 20 percent of the total distance moved from the first position to the second position; and
when moving the push-pull member from the third position to the first position moves said push-pull member past the first position and then back to the first position, the distance past the first position is 20 percent of the total distance from the third position to the first position.

4. The system as set forth in claim 3 comprising said motor including an anti-backlash gear assembly driving said output shaft.

5. The system as set forth in claim 1 or 2, or 3, or 4 wherein the automobile includes a steering wheel, said system comprising a gear selection means mounted on said steering wheel for providing the first and second signals to said transmission shifter means.

6. A transmission shifting system for an automobile, the automobile having a transmission having a push-pull member for operating the transmission movable from a first starting position to a second upshifting or to a third downshift position; the system comprising:
means to drive the push pull-member such that when moving the push-pull member from the second position to the first position moves the push-pull member past the first position and then back to the first position and when moving said push-pull member from the third position to the first position moves said push-pull member past the first position and then back to the first position;
transmission shifter control means for actuating said motor to move the input member move from the from the first position to the second position and back to the first position upon receipt of a first signal, and to move the push-pull member to move from the first position to the third position and back to the first position upon receipt of a second signal; and
second means for providing the first and second signals.

7. The system as set forth in claim 6 wherein:
when moving said push-pull member from the second position to the first position moves said push-pull member past the first position and then back to the first position, the distance past the first position is 20 percent of the total distance moved from the first position to the second position; and
when moving said push-pull member from the third position to the first position moves said push-pull member past the first position and then back to the first position, the distance past the first position is 20 percent of the total distance from the third position to the first position.

8. The system as set forth in claim 7 wherein said means is an electric motor.

9. The system as set forth in claim 8 wherein said electric motor includes an anti-backlash gear train having an output shaft.

10. The system as set forth in claim 6, or 7, or 8, or 9, wherein the automobile includes a steering wheel, said system comprising a gear selection means mounted on said steering wheel for providing the first and second signals to said transmission means.

11. A method of upshifting and downshifting a transmission system for a vehicle, the transmission having a push-pull member for operating the transmission movable from a first starting position to a second upshift or to a third downshift position; the method of upshifting comprising these steps for upshifting;
moving the push-pull member from first position to the second position;
moving the push-pull member back past the first position; and
moving the push-pull member to the first position. the steps of downshifting comprising;
moving the push-pull member from first position to the third position;
moving the push-pull member back past the first position; and
moving the push-pull member to the first position.

12. The method of claim 11 wherein:
in the step of moving the push-pull member back past the first position, the distance past the first position is 20 percent of the total distance moved from the first position to the second position; and
in the step moving the push-pull member back past the first position, the distance past the first position is 20 percent of the total distance from the third position to the first position.
